(19) United States
(12) Patent Application Publication
(10) Pub. No.: US 2026/0318461 A1
(43) Pub. Date: Oct. 15, 2026

(54) WATER-PRESSURE-RESPONSIVE RETRACTABLE WATER HOSES AND METHODS OF USING THEREOF

(71) Applicant: Feibiao ZHANG, Zhejiang (CN)

(72) Inventor: Feibiao ZHANG, Zhejiang (CN)

(73) Assignee: Panan Feihu Plastic Co., Limited, Zhejiang (CN)

(21) Appl. No.: 19/433,032

(22) Filed: Dec. 25, 2025

(30) Foreign Application Priority Data
Dec. 25, 2024 (CN) 202423200634.X

(51) Int. Cl. F16L 55/027; F16L 11/115; F16L 11/20

(52) U.S. Cl. CPC F16L 55/02763; F16L 11/115; F16L 11/20

(57) ABSTRACT

A water-pressure-adjustable retractable water hose includes a pipe body, a connector disposed at an end of the pipe body, and a valve body detachably disposed between the pipe body and the connector. The valve body is configured to selectively modify water pressure characteristics of water flowing through the pipe body. The valve body is selectively installable in a first orientation and a second orientation opposite the first orientation. When installed in the first orientation, the valve body operates in a pressure-boosting configuration, and when installed in the second orientation, the valve body operates in a pressure-reducing configuration. The valve body is removable such that the water hose operates without pressure modification when the valve body is removed.

### CROSS REFERENCE TO RELATED APPLICATIONS

The present disclosure is based on and claims priority to the Chinese patent application No. 202423200634.X, filed on Dec. 25, 2024, the entire content of which is hereby incorporated by reference.

### TECHNICAL FIELD

This application relates to the field of water pipes, and in particular to a water-pressure-responsive retractable water hose.

### BACKGROUND

Unless otherwise indicated herein, the materials described in this section are not prior art to the claims in this application and are not admitted being prior art by inclusion in this section.

Water pipes, pipes for supplying water, are common household items. Since faucets are mostly installed in fixed locations and the water flow direction cannot be changed, they are always connected to water pipes. To meet different needs, water pipes on the market are available in various lengths. A shorter pipe is needed for rinsing items in a sink; a longer pipe is needed for washing floors, cars, or other immovable objects, connected to the faucet and held while rinsing. For ease of use and storage, extendable water pipes have been invented.

Water pressure is usually constant, and existing retractable water pipes cannot change the water pressure according to different user needs, resulting in a generally poor user experience.

To overcome the shortcomings of existing technologies, this application provides a telescopic water pipe with adjustable water pressure. To solve the above-mentioned technical problems, this application provides the following technical solution.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

This disclosure is generally drawn, inter alia, to apparatus, devices, methods, systems, and assemblies related to retractable water pipes, hoses, or combinations thereof.

A telescopic water pipe with adjustable water pressure includes a pipe body and a connector installed at the end of the pipe body. A detachable valve body is provided between the pipe body and the connector. The valve body is configured to increase or decrease the water pressure through which the water flows. The valve body includes a pressure-boosting mode and a pressure-reducing mode. In one embodiment, in pressure-boosting mode, the water pressure increases as the water flows through the valve body installed in the forward direction. In one embodiment, in pressure-reducing mode, water pressure is reduced as the water flows through the valve body installed in the opposite direction.

In one embodiment, the valve body includes several interlocking pressure-changing valves, and a connecting part is provided between every two pressure-changing valves. The valves are detachably connected through the connecting part. Water flows into the valve body through the connector and passes through each pressure-changing valve in sequence. The water pressure increases or decreases after passing through each pressure-changing valve.

In one embodiment, the pressure modifying valve includes a housing and a first pressure modifying valve and a second pressure modifying valve located within the housing, wherein the second pressure modifying valve is reverse-biased and connected to the first pressure modifying valve.

In one embodiment, the first pressure modifying valve includes a first inlet, a first inlet channel extending forward from the first inlet, a first annular channel extending to one side from the first inlet, and a first pressure modifying channel extending forward from the end of the first annular channel and connected to the first inlet channel; the second pressure modifying valve includes a second inlet, a second inlet channel extending forward from the second inlet, a second annular channel extending to one side from the second inlet, and a second pressure modifying channel extending forward from the end of the second annular channel and connected to the second inlet channel; the end of the first inlet channel is connected to the second inlet, water flows into the first inlet channel from the first inlet, and at the same time forms a diversion into the first annular channel, the water in the first annular channel forms a backflow and re-enters the first inlet channel through the first pressure modifying channel, forming a pressurized or depressurized flow into the second inlet.

In one embodiment, a guide portion is provided at the connection between the first annular channel and the first water inlet channel and the first pressure modifying channel. In one embodiment, a guide portion is also provided at the connection between the second annular channel and the second water inlet channel and the second pressure modifying channel.

In one embodiment, the connection includes a threaded connection, and every two pressure valves are detachably connected by threads. In one embodiment, the connecting part includes a snap-fit connection part, and every two pressure valves can be detachably connected by snap-fit.

In one embodiment, the pipe body includes an inner telescopic tube and an outer telescopic tube, with the outer telescopic tube wrapping around the outside of the inner telescopic tube. The inner telescopic tube is composed of several corrugated tubes and several elastic rubber layers arranged longitudinally. The corrugated tubes and rubber layers are integrally formed. The corrugated tubes are separated longitudinally, and the rubber layers are located at the intervals where the corrugated tubes are separated.

In one embodiment, the corrugated pipe comprises a plastic corrugated pipe, and the adhesive layer includes an elastic plastic adhesive layer and a latex adhesive layer.

In one embodiment, the inner surface of the outer telescopic tube is provided with a lower corrugated surface, and the outer surface of the inner telescopic tube is provided with an upper corrugated surface adapted to the lower corrugated surface.

Compared with the prior art, the significant technical advantages of the solution disclosed by this application include without limitation: a pressurization mode and a depressurization mode. In pressurization mode, the valve body is installed in the forward direction, and the water pressure increases as water flows through the valve body. When the water pressure is too low, the valve body can be installed in the forward direction to increase the water pressure at the outlet of the water pipe. In depressurization mode, when the water pressure is too high, the valve body can be installed in the reverse direction. The valve body is detachable. When the water pressure is sufficient, there is no need to use the valve body for pressurization or depressurization. The valve body can be detached. This application can switch between different modes according to the user's different water pressure requirements. It is simple and convenient to use, has multiple functions, meets the user's multi-functionality requirements, and provides a good user experience.

In one embodiment, the valve body may be composed of several pressure-changing valves. The water pressure increases or decreases with each pressure-changing valve. Therefore, the pressure-boosting or pressure-reducing performance of the valve body can be controlled by the number of pressure-changing valves. Users can actively adjust the pressure-changing performance of the valve body according to the water pressure, making it highly practical.

In one embodiment, the pipe body may include an inner telescopic pipe and an outer telescopic pipe. The inner telescopic pipe is composed of several corrugated pipes and several elastic rubber layers combined longitudinally. The corrugated pipes are separated longitudinally, and the rubber layers are located at the intervals between the corrugated pipes, which improves the telescopic flexibility of the inner telescopic pipe, enhances the inner layer's resistance to bursting, reduces the possibility of bursting under water pressure, and improves the adhesion strength between the inner and outer layers. Through various structures, such as a combination of corrugated and solid forms, the service life of the water pipe is extended while enhancing its telescopic performance. Traditional water pipes are usually corrugated pipes throughout, which are prone to breakage under excessive water pressure. The inner telescopic pipe of this design is composed of corrugated pipes and rubber layers. Because the rubber layers can withstand stress and their own elasticity allows for a larger deformation, the inner telescopic pipe can expand more under excessive water pressure, effectively preventing the water pipe from breaking.

In another aspect, the application provides a detachable valve body for selectively modifying water pressure characteristics in a water hose. In one embodiment, the detachable valve body comprises: a housing having an inlet end and an outlet end; and at least one pressure-changing valve module disposed within the housing, wherein the valve body is configured to be selectively installable in a first orientation and a second orientation opposite the first orientation between a hose body and a connector, wherein, when installed in the first orientation, the valve body operates in a pressure-boosting mode in which water flowing through the valve body experiences an increased outlet pressure relative to an inlet pressure, wherein, when installed in the second orientation, the valve body operates in a pressure-reducing mode in which water flowing through the valve body experiences a reduced outlet pressure relative to an inlet pressure, and wherein the valve body is detachable such that it is removable from the water hose to permit water flow without pressure modification.

In one embodiment, the pressure-changing valve module comprises a primary flow channel and a secondary annular return channel configured to re-introduce a portion of water into the primary flow channel.

In one embodiment, the valve body comprises a plurality of pressure-changing valve modules arranged in series within the housing, such that water flowing through the valve body sequentially passes through each pressure-changing valve module.

In one embodiment, the adjacent pressure-changing valve modules are detachably connected to one another by a connecting structure.

In one embodiment, each pressure-changing valve module comprises: a primary flow channel configured to conduct a main water flow; and a secondary annular flow channel configured to divert a portion of the water from the primary flow channel and re-introduce the diverted water back into the primary flow channel, thereby modifying water pressure characteristics within the valve body.

In one embodiment, the primary flow channel and the secondary annular flow channel are arranged such that reversing an installation orientation of the valve body reverses a pressure-boosting effect and a pressure-reducing effect produced by the valve body.

In a further aspect, the application provides a detachable valve body for use with a water hose. In one embodiment, the detachable valve body comprising: a housing having an inlet and
an outlet; and
a plurality of pressure-changing valve modules disposed within the housing and arranged in series along a flow direction. In one embodiment, each pressure-changing valve module comprises: (i) a primary flow channel extending between the inlet and the outlet; and (ii) a secondary annular flow channel branching from the primary flow channel and configured to return a portion of water back into the primary flow channel; wherein the secondary annular flow channel is positioned and oriented relative to the primary flow channel such that interaction between a main flow and a return flow modifies pressure characteristics of water exiting the valve body.

In a further aspect, the application provides a method of modifying water pressure characteristics in a water hose. In one embodiment, the method comprises the steps of: directing water into a detachable valve body having a housing with an inlet and an outlet; causing the water to flow through a primary flow channel within the valve body; optionally diverting a portion of the water from the primary flow channel into a secondary annular flow channel within the valve body; returning the diverted portion of the water from the secondary annular flow channel back into the primary flow channel; and discharging water from the outlet of the valve body, wherein interaction between a main flow in the primary flow channel and a return flow from the secondary annular flow channel modifies pressure characteristics of the discharged water.

### BRIEF DESCRIPTION OF THE DRAWINGS

The foregoing and other features of this disclosure will become more fully apparent from the following description and appended claims, taken in conjunction with the accompanying drawings. The drawings are not necessarily drawn to scale. Understanding that these drawings depict only example embodiments arranged in accordance with the disclosure and are, therefore, not to be considered limiting of its scope, the disclosure will be described with additional specificity and detail through use of the accompanying drawings, in which:

FIG. 1 is a side view of a representative embodiment;

FIG. 2 is a partial cross-sectional view of FIG. 1;

FIG. 3 is a cross-sectional view of an example embodiment;

FIG. 4 is a schematic diagram of an example embodiment;

FIG. 5 is a schematic diagram of an example embodiment;

FIG. 6 is a schematic diagram of the pressure modifying valve of example embodiments;

FIG. 7 is a schematic diagram of the pressure modifying valve of an example embodiment;

FIG. 8 is a cross-sectional view of the tube body of an example embodiment;

FIG. 9 is a schematic diagram of the tube body of an example embodiment;

FIG. 10 is a schematic diagram of the connector of an example embodiment;

FIG. 11 is a schematic diagram of the connector of an example embodiment;

FIG. 12 is a schematic diagram of the connector of an example embodiment; and

FIG. 13 is a schematic diagram of the connector of an example embodiment.

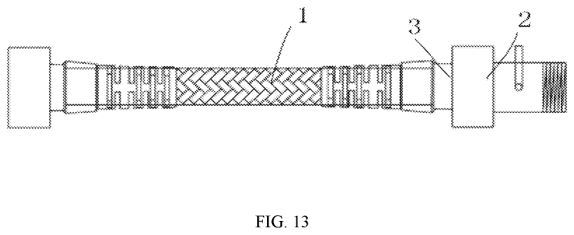

Reference Numerals:
1. Pipe body; 2. Connector; 3. Valve body; 4. Connecting part; 5. Housing; 6. Pressure modifying valve; 7. First pressure modifying valve; 8. Second pressure modifying valve; 9. First water inlet;
10. First water inlet channel; 11. First annular channel; 12. First pressure modifying valve channel;
13. Second water inlet; 14. Second water inlet channel; 15. Second annular channel; 16. Second pressure modifying valve channel; 17. Guide part; 18. Inner telescopic pipe; 19. Outer telescopic pipe; 20. Corrugated pipe; 21. Adhesive layer; 22. Lower corrugated surface; 23. Upper corrugated surface; 24. Locking element.

### DETAILED DESCRIPTION

In the following detailed description, reference is made to the accompanying drawings, which form a part hereof. In the drawings, similar symbols identify typically similar components, unless context dictates otherwise. The illustrative embodiments described in the detailed description, drawings, and claims are not meant to be limiting. Figures, can be arranged, substituted, combined, separated, and designed in a wide variety of different configurations, all of which are explicitly contemplated herein. All patents, published patent applications, and other publications referred to herein are incorporated by reference in their entirety with respect to the related technology.

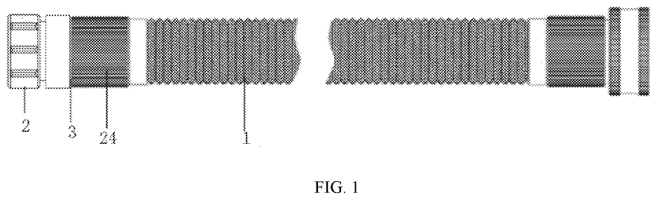

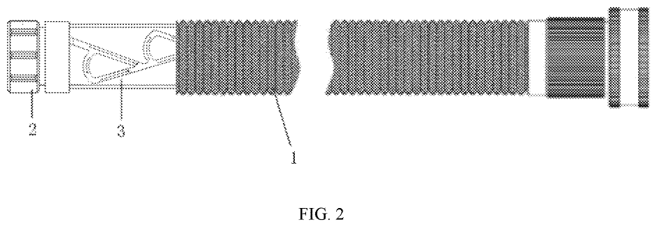

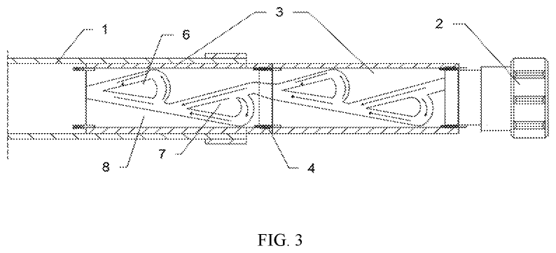

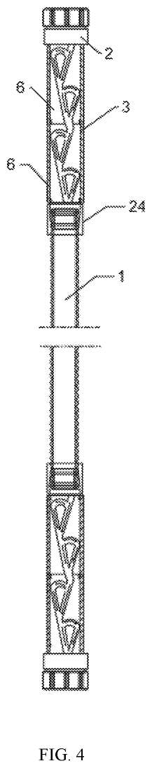

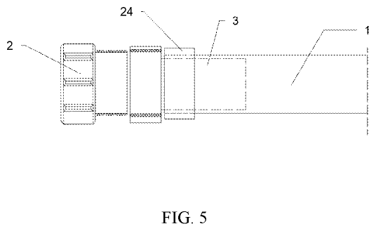

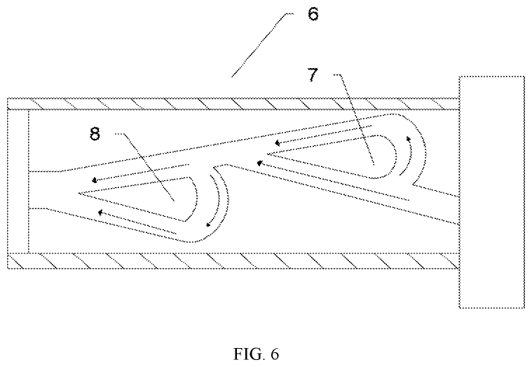

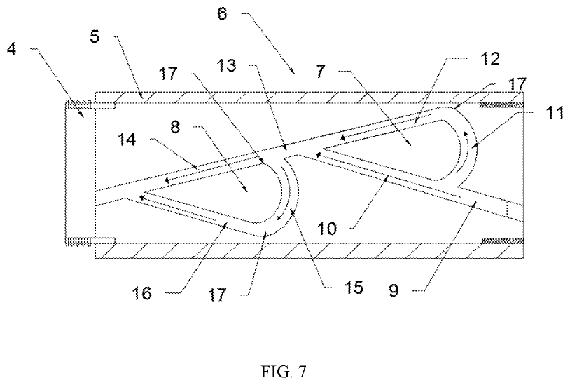

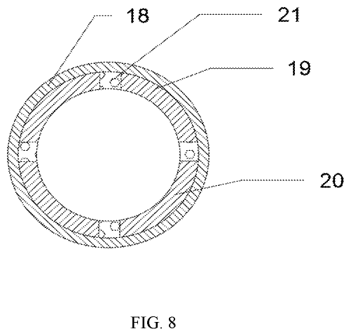

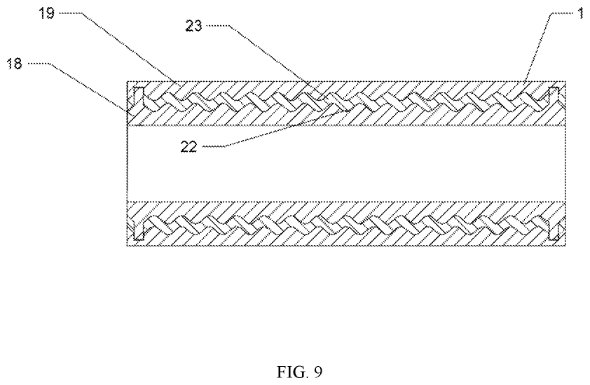

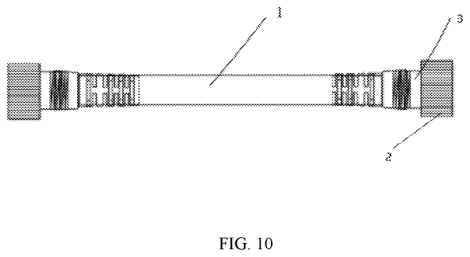

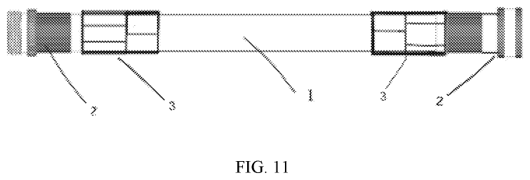

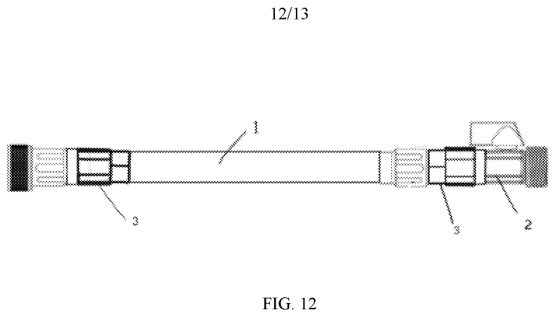

As shown in FIGS. 1-12, a telescopic water pipe with adjustable water pressure includes a pipe body 1 and a connector 2 installed at the end of the pipe body 1. The connector 2 is used to install on a faucet. A valve body 3 is provided between the pipe body 1 and the connector 2. The valve body 3 increases or decreases the water pressure flowing through the pipe, realizing pressure variation in the water pipe. The valve body 3 is detachably connected to the pipe body 1 and the connector 2. The valve body 3 includes a pressurization mode and a depressurization mode. When the water pressure is too low, the pressurization mode can be used to increase the water pressure at the outlet of the pipe, which can be used for washing cars, rinsing floors, etc. When the water pressure is too high, the depressurization mode can be switched to, which can be used for washing hands and dishes in a sink, etc. In the pressurization mode, the valve body 3 is installed in the forward direction, and the water pressure increases when the water flows through the valve body 3, which is used to increase the water pressure at the outlet of the pipe. In the depressurization mode, when the water pressure is too high, the valve body 3 can be installed in the reverse direction to decrease the water pressure at the outlet of the pipe. When the water pressure at the faucet is sufficient for the user, the valve body 3 is not needed, and the valve body can be removed, and the pipe 1 and connector 2 can be used alone. This application can switch between different modes according to the user's different water pressure requirements. It is simple and convenient to use, has many functions, meets the user's multi-functionality, and provides a good user experience.

The valve body 3 includes several connectable pressure-changing valves 6. Water flows into the valve body 3 through the connector 2 and passes through each pressure-changing valve 6 in sequence. When the valve body 3 is installed in the forward direction, the water pressure increases with each pressure-changing valve 6. When the valve body 3 is installed in the reverse direction, the water pressure decreases with each pressure-changing valve 6. Therefore, by increasing the number of pressure-changing valves 6, the pressure-increasing or depressurizing performance of the valve body 3 can be adjusted. Users can actively adjust the pressure-changing performance of the valve body 3 according to the water pressure, making it highly practical.

The pressure modifying valve 6 includes a housing 5 and a first pressure modifying valve 7 and a second pressure modifying valve 8 installed in the housing 5. The second pressure modifying valve 8 is opposite to the first pressure modifying valve 7, and the head end of the first pressure modifying valve 7 is connected to the tail end of the second pressure modifying valve 8. The two are interconnected. Water flows from the first pressure modifying valve 7 of one of the pressures modifying valves 6 into the second pressure modifying valve 8 and then flows into the adjacent first pressure modifying valve 7, and so on. The water pressure changes with each pressure modifying valve 6.

The first pressure modifying valve 7 includes a first water inlet 9, a first water inlet channel 10 extending forward from the first water inlet 9, a first annular channel 11 extending to one side from the first water inlet 9, and a first pressure modifying channel 12 extending forward from the end of the first annular channel 11 and communicating with the end of the first water inlet channel 10.

The second pressure modifying valve 8 includes a second water inlet 13, a second water inlet channel 14 extending forward from the second water inlet 13, a second annular channel 15 extending to one side from the second water inlet 13, and a second pressure modifying channel 16 extending forward from the end of the second annular channel 15 and connecting to the end of the second water inlet channel.

The first pressure modifying valve 7 is positioned at a higher height than the second pressure modifying valve 8. The first inlet of 8 is located at the lower end of the first pressure modifying valve 7. Since the second pressure modifying valve 8 is positioned in the opposite direction to the first pressure modifying valve 7, the second inlet 13 is located at the upper end of the second pressure modifying valve 8. The end of the first inlet channel 10 is connected to the second inlet 13. Water flows into the first inlet channel 10 through the first inlet 9, simultaneously forming a branch flow into the first annular channel 11. The water in the first channel 10 flows into the second inlet 13, thus realizing the flow of water from the first pressure modifying valve 7 to the second pressure modifying valve 8. The water in the first annular channel 11 forms a backflow, flowing back into the first inlet channel 10 through the first pressure modifying valve channel 12, and pushing the water originally flowing in the first inlet channel 10 to increase the water pressure at the outlet of the first pressure modifying valve 7, achieving a pressurization effect.

Similarly, water flows from the second inlet 13 into the second inlet channel 14, simultaneously branching into the second annular channel 15. Water in the second channel 13 flows into the first inlet 13 of the next pressure modifying valve 6, thus circulating. Water in the second annular channel 15 forms a backflow, flowing back into the second inlet channel 14 through the second pressure modifying valve channel 16, pushing the water originally flowing in the second inlet channel 14 to increase the water pressure at the outlet of the second pressure modifying valve 8, achieving a pressurization effect. Therefore, the pressurization performance of the valve body 3 can be controlled by setting the number of pressure modifying valves 6. If the valve body 3 is installed in reverse, water flowing through each first pressure modifying valve 7 or second pressure modifying valve 8 needs to flow upwards into the first annular channel 11 or second annular channel 15, creating resistance and reducing water pressure. Furthermore, the backflowing water through the first pressure modifying valve channel 12 or second pressure modifying valve channel 16 exerts a backward pushing force on the normally flowing water, reducing its flow velocity and achieving a pressure reduction effect.

The angle between the first water inlet channel 10 and the first pressure-changing channel 12 is 20-35 degrees. If the angle is greater than 35 degrees, the water pressure required for water to flow into the first pressure-changing channel 12 is relatively large; if the water pressure is too low, it may not be able to pass through the first annular channel 11. The water flows downwards at an angle in the first pressure-changing channel 12. If the angle is less than 20 degrees, it cannot provide a good downward impact force for the water flow, and the pressurization effect is relatively weak. Therefore, an angle between the first water inlet channel 10 and the first pressure-changing channel 12 within the range of 20-35 degrees is most suitable.

A guide section 17 is provided at the connection between the first annular channel 11 and the first water inlet channel 10 and the first pressure changing channel 12. A guide section 17 is also provided at the connection between the second annular channel 15 and the second water inlet channel 14 and the second pressure changing channel 16. The guide section 17 is arc-shaped, which can better guide the flow and direction of water.

The connecting part 4 includes a threaded connection, where two adjacent pressure modifying valves 6 are joined by threads. When the threads are fully tightened, the first pressure modifying valve 7 and the second pressure modifying valve 8 are aligned, allowing water flow. The connecting part 4 also includes a snap-fit connection, where two adjacent pressure modifying valves 6 are joined by snap-fit and slot engagement, making operation simple and convenient for users to disassemble or install. Similarly, the connector 2 can also be detachably connected to the valve body 3 by threads or snap fit.

The tube 1 is fitted onto the outside of the valve body 3. The tube 1 is locked onto the outer surface of the valve body 3 by a locking member 24 to prevent the tube 1 from separating from the valve body 3. The locking method of the locking member 24 is as follows: the tube 1 is fitted onto the outer surface of the valve body 3, and a conical plastic part is fitted onto the outer surface of the tube 1. The locking member 24 is then rotated onto the plastic part by means of threads. The more it is rotated, the more the plastic part is squeezed until the tube 1 is tightly clamped onto the valve body 3.

The pipe body 1 includes an inner telescopic tube 18 and an outer telescopic tube 19. The outer telescopic tube 19 wraps around the outside of the inner telescopic tube 18. During use, water flows into the inner telescopic tube 18, and the water pressure causes the pipe body 1 to expand and contract. The outer telescopic tube 19 is made of an elastic material and includes a soft rubber outer telescopic tube. During use, the inner telescopic tube 18 and the outer telescopic tube 19 expand and contract synchronously. When water flows into the pipe body 1, the pipe body 1 is impacted and elongated by the water pressure. The greater the water pressure, the longer the inner telescopic tube 18 and the outer telescopic tube 19 extend; the lower the water pressure, the less they extend. When water is stopped flowing into the pipe body 1, the water pressure decreases, and the inner telescopic tube 18 and the outer telescopic tube 19 retract due to their own rebound force. When not in use, the pipe body 1 is in a contracted state, with a small volume and light weight, making it convenient for users to carry when traveling.

The inner telescopic tube 18 comprises several corrugated tubes 20 and several elastic rubber layers 21 (interchangeably, elastic segments, adhesive layers, elastic adhesive segments or layers) arranged longitudinally. The corrugated tubes 20 are separated longitudinally, and the rubber layers 21 are located at the intervals between the separations of the corrugated tubes 20, with one rubber layer 21 between every two sections of corrugated tubes 20. The corrugated tubes 20 are made of plastic and expand and contract through the opening of multiple pleats; the elastic rubber layers 21 are made of rubber or latex and have good elasticity, expanding and contracting through the elasticity of their own materials. Traditional water pipes are typically corrugated throughout. In contrast, the inner expansion layer 18 of this design combines multiple longitudinal corrugated pipes 20 and a rubber layer 21. Due to the stress that the rubber layer 21 can withstand and its own elasticity, it can deform significantly. When the water pressure is too high, the water pipe can expand to a wider size. The rubber layer 21 is less prone to breakage than the corrugated pipe 5, thus effectively preventing water pipe breakage. This also improves the extensibility of the inner expansion pipe 18, enhances the inner layer's resistance to bursting, reduces the possibility of bursting under water pressure, and improves the bonding strength between the inner and outer layer materials. Through various structures, such as a combination of corrugated and solid forms, the service life of the water pipe is extended while enhancing its expansion and contraction performance.

The corrugated pipe 20 and the elastic adhesive layer 21 are integrally formed, avoiding the need for a connecting structure, increasing strength, and facilitating production.

Outer telescopic tube 19 is provided with a lower corrugated surface 22, and the outer surface of the inner telescopic tube 18 is provided with an upper corrugated surface 23 adapted to the lower corrugated surface 22. The upper corrugated surface 23 and the lower corrugated surface 22 fit together, which can further increase the contact area between the outer telescopic tube 19 and the inner telescopic tube 18, increase the friction, and make the inner telescopic tube 18 and the outer telescopic tube 19 fit more tightly and not easily separated.

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art may translate from the plural to the singular and/or from the singular to the plural as is appropriate to the context and/or application. The various singular/plural permutations may be expressly set forth herein for the sake of clarity.

It will be apparent to those skilled in the art that the present application is not limited to the details of the exemplary embodiments described above, and that the application can be implemented in other specific forms without departing from its spirit or essential characteristics. Therefore, the embodiments should be considered illustrative and non-limiting in all respects, and the scope of the application is defined by the appended claims rather than the foregoing description. Thus, all variations falling within the meaning and scope of equivalents of the claims are intended to be included within the present application, and no reference numerals in the claims should be construed as limiting the scope of the claims.

What is claimed is:

1. A water-pressure-adjustable retractable water hose, comprising:
a pipe body;
a connector disposed at an end of the pipe body; and
a valve body detachably disposed between the pipe body and the connector,
wherein the valve body is configured to selectively modify water pressure characteristics of water flowing through the pipe body,
wherein the valve body is selectively installable in a first orientation or a second orientation opposite the first orientation,
wherein, when the valve body is installed in the first orientation, the valve body operates in a pressure-boosting mode in which water flowing through the valve body experiences an increased effective outlet pressure relative to an inlet pressure,
wherein, when the valve body is installed in the second orientation, the valve body operates in a pressure-reducing mode in which water flowing through the valve body experiences a reduced outlet pressure relative to an inlet pressure, and
wherein the valve body is removable from between the pipe body and the connector such that the water hose operates without pressure modification when the valve body is removed.

2. The water-pressure-adjustable retractable water hose of claim 1, wherein the valve body comprises a plurality of pressure-modifying valve modules arranged in series, such that water flowing through the valve body sequentially passes through each pressure-modifying valve module.

3. The water-pressure-adjustable retractable water hose of claim 2, wherein adjacent pressure-modifying valve modules are detachably connected to one another by a connection structure.

4. The water-pressure-adjustable retractable water hose of claim 3, wherein the connection structure comprises a threaded connection or a snap-fit connection.

5. The water-pressure-adjustable retractable water hose of claim 2, wherein each pressure-modifying valve module comprises a primary flow channel configured to conduct a main water flow; and a secondary annular flow channel configured to direct a portion of the water into a return flow that re-enters the primary flow channel, contributing to modification of the water pressure characteristics.

6. The water-pressure-adjustable retractable water hose of claim 5, wherein the primary flow channel and the secondary annular flow channel are arranged such that reversal of the valve body between the first orientation and the second orientation reverses a pressure-boosting effect and a pressure-reducing effect.

7. The water-pressure-adjustable retractable water hose of claim 1, wherein the pipe body comprises an inner telescopic tube and an outer telescopic tube surrounding the inner telescopic tube, the inner telescopic tube being configured to expand and contract in response to water pressure within the pipe body.

8. The water-pressure-adjustable retractable water hose of claim 7, wherein the inner telescopic tube comprises a plurality of corrugated tube sections and a plurality of elastic segments arranged alternately along a longitudinal direction of the pipe body.

9. The water-pressure-adjustable retractable water hose of claim 8, wherein the corrugated tube sections and the elastic segments are integrally formed, and wherein the elastic segments are configured to accommodate radial expansion under elevated water pressure to reduce a risk of rupture of the inner telescopic tube.

10. The water-pressure-adjustable retractable water hose of claim 9, wherein the corrugated tube sections comprise plastic material, and are configured to expand and contract through the opening of multiple pleats.

11. The water-pressure-adjustable retractable water hose of claim 9, wherein the elastic segments comprise elastomeric material.

12. The water-pressure-adjustable retractable water hose of claim 9, wherein the elastic segments comprise latex, rubber, or a combination thereof.

13. The water-pressure-adjustable retractable water hose of claim 7, wherein the outer telescopic tube comprises an elastic material.

14. The water-pressure-adjustable retractable water hose of claim 7, wherein the outer telescopic tube comprises a soft rubber material.

15. The water-pressure-adjustable retractable water hose of claim 7, wherein an inner surface of the outer telescopic tube comprises a first corrugated surface, and an outer surface of the inner telescopic tube comprises a second corrugated surface complementary to the first corrugated surface, such that engagement between the first and second corrugated surfaces increases frictional coupling between the inner and outer telescopic tubes.
